(19) United States
(12) Patent Application Publication
(10) Pub. No.: US 2023/0359691 A1
(43) Pub. Date: Nov. 9, 2023

(54) PROGRAM GENERATION DEVICE AND METHOD

(71) Applicant: NEC Corporation, Minato-ku, Tokyo (JP)

(72) Inventors: Takuya ARAKI, Tokyo (JP); Fumiyo TAKANO, Tokyo (JP); Hiroaki INOUE, Tokyo (JP); Motoi SUZUKI, Tokyo (JP); Yuki KOBAYASHI, Tokyo (JP); Takahiro NISHIMURA, Tokyo (JP); Hiroshi CHISHIMA, Tokyo (JP); Akihiro YATABE, Tokyo (JP)

(73) Assignee: NEC Corporation, Minato-ku, Tokyo (JP)

(21) Appl. No.: 18/023,436

(22) PCT Filed: Sep. 3, 2020
(86) PCT No.: PCT/JP2020/033421

§ 371 Date: Feb. 27, 2023

(51) Int. Cl. G06F 17/11

(52) U.S. Cl. CPC G06F 17/11

(57) ABSTRACT

The conversion means 72 generates a program for deriving a QUBO matrix that is a matrix that defines an energy function of QUBO, by converting a description of a natural language representing a combinatorial optimization problem into a description of the program for deriving the QUBO matrix. It is possible to generate a program for deriving a QUBO matrix based on a description of a natural language representing a combinatorial optimization problem.

### TECHNICAL FIELD

The present invention relates to a program generation device, a program generation method, a computer-readable recording medium in which a program generation program is recorded, for generating a program for deriving a QUBO (Quadratic Unconstrained Binary Optimization) matrix.

### BACKGROUND ART

An energy function of QUBO is used in solving combinatorial optimization problems. Examples of combinatorial optimization problems include the vertex covering problem, the traveling salesman problem, a four color problem and the knapsack problem. However, combinatorial optimization problems are not limited to these problems.

In QUBO, states of individual spins are represented by “1” or “0”.

When solving a combinatorial optimization problem, the first step is to create an expression representing the energy in the combinatorial optimization problem. For example, when solving the traveling salesman problem, an expression representing the energy in the traveling salesman problem is created. Then, the expression representing the energy in the combinatorial optimization problem is converted to the energy function of QUBO. This conversion method is known.

The energy function of QUBO is expressed as in Expression (1) below.

$$H = {\sum }_{i j} {Q}_{i j} {q}_{i} {q}_{j} \qquad \text{[Math. 1]}$$

Both i and j in Expression (1) are variables representing a spin. In addition, qᵢ in Expression (1) is a variable representing the state of spin i, and qⱼ is a variable representing the state of spin j. Qᵢⱼ in Expression (1) is a constant corresponding to a combination of spin i and spin j. For each combination of possible value of i and possible value of j, Qᵢⱼ is determined as a constant.

There are K² constants Qᵢⱼ in Expression (1) when the number of spins is K. A set of constants Qᵢⱼ is represented by a matrix with K rows and K columns. That is, the constant Qᵢⱼ corresponding to a combination of two spins is an element of the matrix with K rows and K columns. This matrix with K rows and K columns is a matrix that defines the energy function of QUBO (see Expression (1)), and is denoted as a QUBO matrix.

The fact that the QUBO matrix is determined means that the energy function of QUBO is determined.

A device that solves a combinatorial optimization problem is denoted as a solver. When the QUBO matrix is input to the solver, the solver finds the states of individual spins in which, for example, the energy indicated by the energy function of QUBO is as small as possible as the solution to the combinatorial optimization problem.

Also, PTL 1 describes coding a computational problem into a problem Hamiltonian.

In addition, PTL 2 describes a technique in which storage means storing patterns is provided in advance, and for determining whether or not a part in an input sentence is used as an idiomatic expression by comparing and matching the input sentence and the contents stored in the storage means.

### CITATION LIST

### Patent Literature

PTL 1: Japanese Patent Application Laid-Open No. 2018-529142
PTL 2: Japanese Patent Application Laid-Open No. H04-60767

### SUMMARY OF INVENTION

### Technical Problem

The process of finding the QUBO matrix is explained using the vertex covering problem as an example. In the vertex covering problem, a graph with multiple edges, each edge connecting vertices is given. The vertex covering problem is a problem of finding a set of vertices, which satisfies the condition that all individual edges are connected to one of the vertices belonging to the set, and which has the minimum number of vertices belonging to the set.

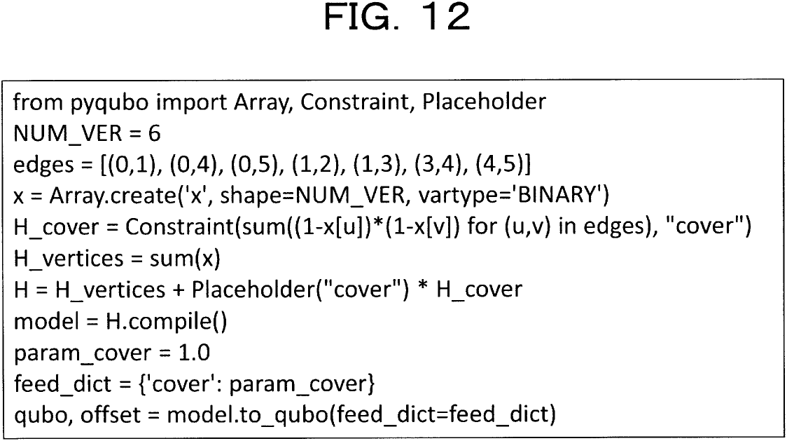

FIG. 11 is a schematic diagram showing an example of a set of vertices that is a solution to the vertex covering problem. In FIG. 11, the number shown near each vertex is an identification number to identify the vertex. The vertices shown in black represent vertices that belong to the set of vertices which is the solution, and the vertices shown in white represent vertices that do not belong to the set of vertices which is the solution. In the example shown in FIG. 11, vertices 1, 4, and 5 belong to the set which is the solution. All individual edges are connected to one of the vertices 1, 4, or 5.

It is assumed that q_{vector} is a vector representing the state of each vertex, and q₀, q₁, ..., qᵢ, ... are elements of q_{vector}. When any element qᵢ of q_{vector} is focused on, qᵢ = 1 if vertex i is included in the set of vertices which is the solution, and q = 0 if vertex i is not included in the set of vertices which is the solution. In other words, the value of each element of q_{vector} is either 1 or 0. Since the number of vertices in the set which is the solution is minimized, the number of elements “1” in q_{vector} is minimized. Therefore, the value of Expression (2) shown below is minimized.

$${H}_{v e r t} = {\sum }_{i} {q}_{i} \qquad \text{[Math. 2]}$$

The edge connecting vertex u and vertex v is denoted as (u,v). In the example shown in FIG. 11, when the set of the edges is denoted as E, E is represented as E = [(0, 1), (0,4), (0,5), (1,2), (1,3), (3,4), (4,5)]. Here, the edge (u,v) is focused on. If at least one of the vertices u and v connected by this edge belongs to the set which is the solution, then (1-qᵤ) (1-qᵥ) = 0. Therefore, Expression (3) below needs to be 0.

$${H}_{c o v e r} = {\sum }_{\left(u , v\right) ∈ E} \left(1 - {q}_{u}\right) \left(1 - {q}_{v}\right) \qquad \text{[Math. 3]}$$

It is assumed that λ_{cover} is a constant to balance Hᵥₑᵣₜ and H_{cover}. The vertex covering problem is then expressed as Hᵥₑᵣₜ + λ_{cover} H_{cover}. This expression may be converted to the energy function of QUBO. In other words, the QUBO matrix may be determined based on this expression. As already explained, it is known how to convert the expression representing energy in a combinatorial optimization problem to the energy function of QUBO.

However, it can be difficult for humans to determine the QUBO matrix in this way. Therefore, software for deriving the QUBO matrix has been developed. Hereafter, software for deriving the QUBO matrix is referred to as QUBO matrix derivation software. PyQUBO (registered trademark) is known as an example of QUBO matrix derivation software. In the case of PyQUBO, the program for deriving the QUBO matrix corresponding to the above vertex covering problem is described as illustrated in FIG. 12. When the QUBO matrix is derived by the program illustrated in FIG. 12, and the QUBO matrix is input to the solver, the solver will solve the above vertex covering problem.

However, a description of the program illustrated in FIG. 12 requires specialized knowledge and a generation of the program for deriving the QUBO matrix is also not easy for the user. It is also difficult for the end user to change the program illustrated in FIG. 12 as the content of the combinatorial optimization problem changes.

On the other hand, it is relatively easy for users to describe a combinatorial optimization problem in natural language.

Therefore, the object of the present invention is to make it possible to generate a program for deriving a QUBO matrix based on a description of a natural language representing a combinatorial optimization problem.

### Solution to Problem

A program generation device according to the present invention includes: conversion means for generating a program for deriving a QUBO (Quadratic Unconstrained Binary Optimization) matrix that is a matrix that defines an energy function of QUBO, by converting a description of a natural language representing a combinatorial optimization problem into a description of the program for deriving the QUBO matrix.

A program generation method according to the present invention is implemented by a computer, and comprises: generating a program for deriving a QUBO (Quadratic Unconstrained Binary Optimization) matrix that is a matrix that defines an energy function of QUBO, by converting a description of a natural language representing a combinatorial optimization problem into a description of the program for deriving the QUBO matrix.

A computer-readable recording medium according to the present invention is a computer-readable recording medium in which a program generation program is recorded, wherein the program generation program causes a computer to execute: a conversion process of generating a program for deriving a QUBO (Quadratic Unconstrained Binary Optimization) matrix that is a matrix that defines an energy function of QUBO, by converting a description of a natural language representing a combinatorial optimization problem into a description of the program for deriving the QUBO matrix.

### Advantageous Effects of Invention

According to the present invention, it is possible to generate a program for deriving a QUBO matrix based on a description of a natural language representing a combinatorial optimization problem.

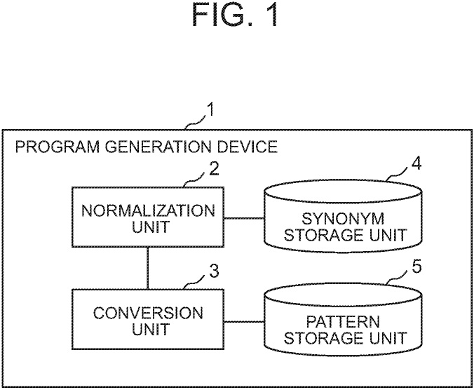

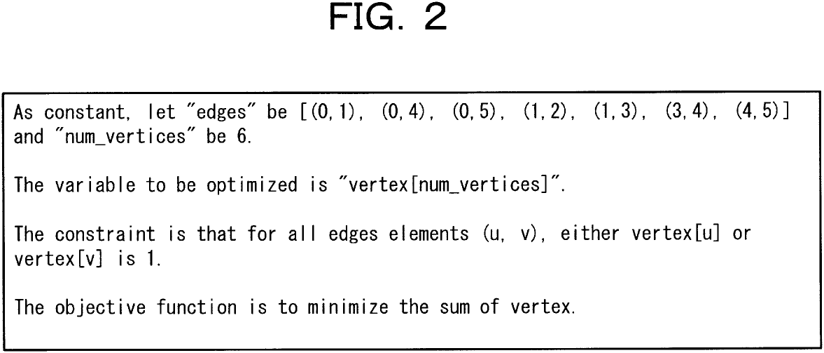

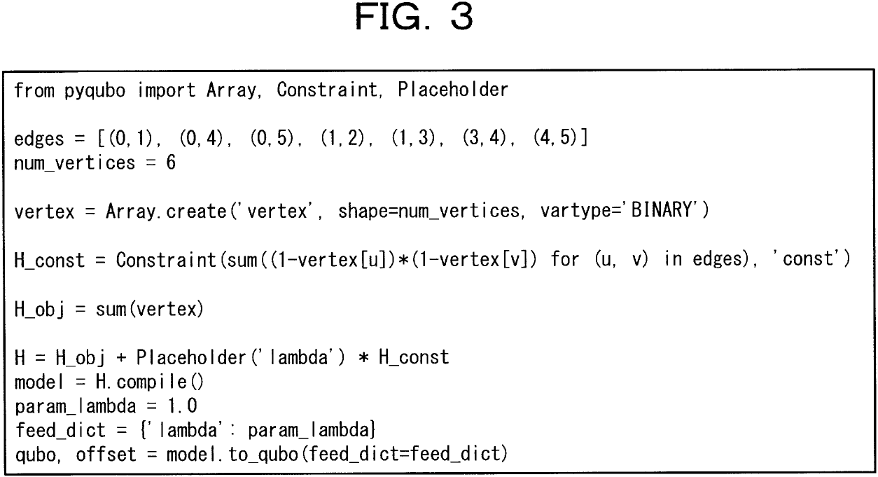

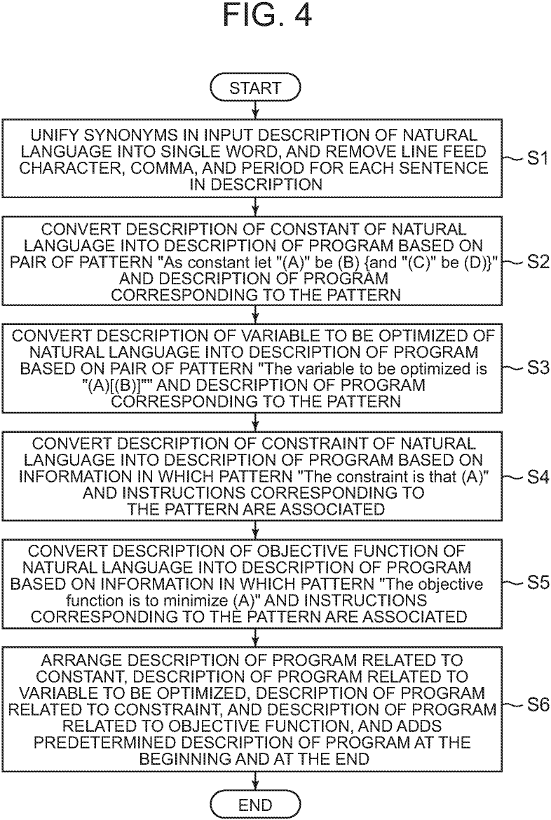

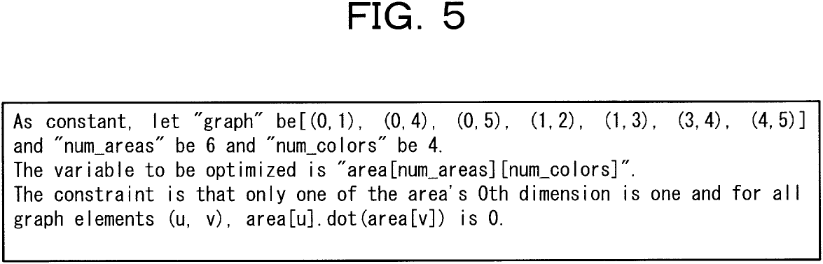

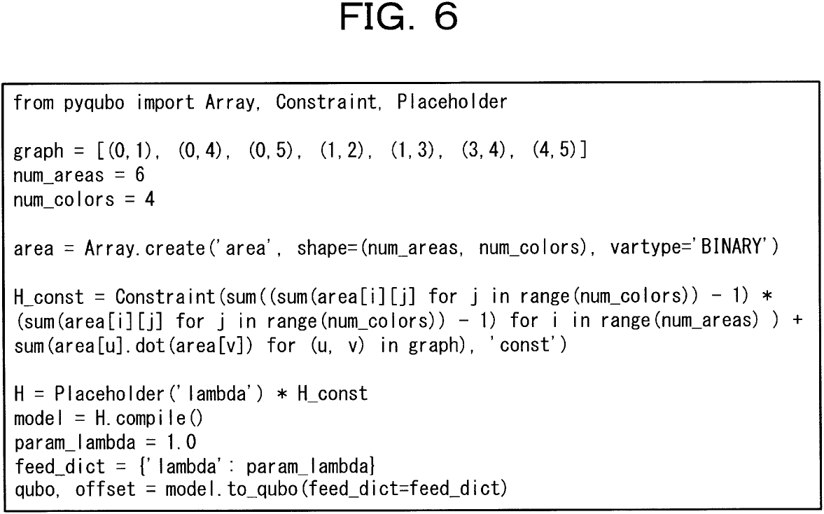

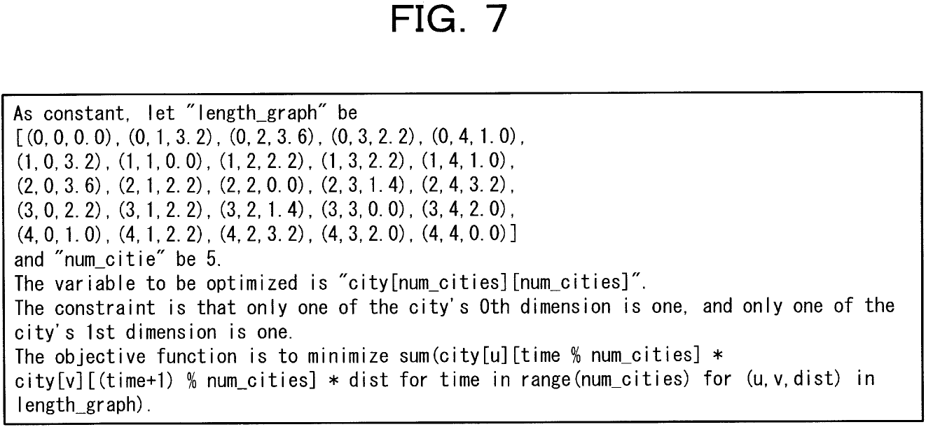

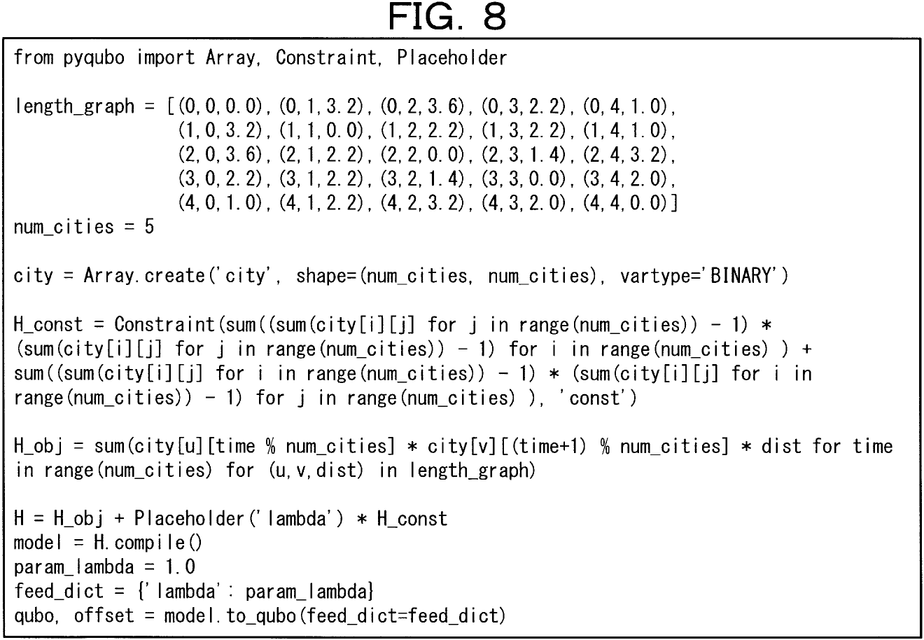

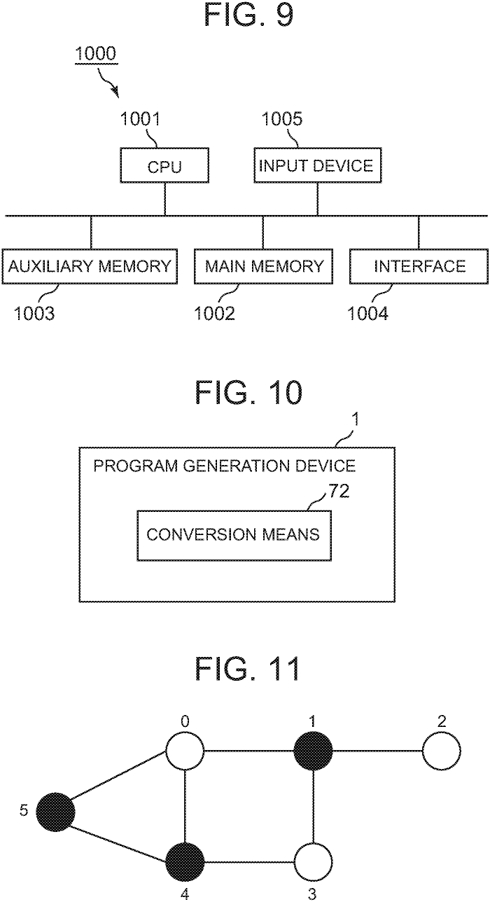

### BRIEF DESCRIPTION OF DRAWINGS

[FIG. 1] It depicts a block diagram showing an example configuration of a program generation device of the example embodiment of the present invention.

[FIG. 2] It depicts a diagram showing an example of a description of a natural language representing a combinatorial optimization problem.

[FIG. 3] It depicts a diagram showing a program generated by the program generation device of the example embodiment of the present invention, based on the description of the natural language illustrated in FIG. 2.

[FIG. 4] It depicts a flowchart showing an example of a processing flow of the example embodiment of the present invention.

[FIG. 5] It depicts a diagram showing an example of a description of a natural language representing a four color problem.

[FIG. 6] It depicts a diagram showing a program generated by the program generation device of the example embodiment of the present invention, based on the description of the natural language illustrated in FIG. 5.

[FIG. 7] It depicts a diagram showing an example of a description of a natural language representing a traveling salesman problem.

[FIG. 8] It depicts a diagram showing a program generated by the program generation device of the example embodiment of the present invention, based on the description of the natural language illustrated in FIG. 7.

[FIG. 9] It depicts a schematic block diagram showing an example of computer configuration related to the program generation device of the example embodiment of the present invention.

[FIG. 10] It depicts a block diagram showing an overview of the program generation device of the present invention.

[FIG. 11] It depicts a schematic diagram showing an example of a set of vertices that is a solution to the vertex covering problem.

[FIG. 12] It depicts a diagram showing an example of a program for deriving a QUBO matrix corresponding to the vertex covering problem.

### DESCRIPTION OF EMBODIMENTS

An example embodiment of the present invention is described below with reference to the drawings.

In the example embodiment below, the QUBO matrix derivation software is PyQUBO as an example. However, the QUBO matrix derivation software is not limited to PyQUBO.

FIG. 1 is a block diagram showing an example configuration of a program generation device of the example embodiment of the present invention. The program generation device 1 includes a normalization unit 2, a conversion unit 3, a synonym storage unit 4, and a pattern storage unit 5.

A description of a natural language representing a combinatorial optimization problem is input to the normalization unit 2, via an input device (e.g., a keyboard, etc., not shown in FIG. 1).

An example of an input description of a natural language is shown in FIG. 2. FIG. 2 is an example of a description of a natural language representing the aforementioned vertex covering problem. In the present example embodiment, the case in which the description of a natural language representing the combinatorial optimization problem is an English description, as shown in FIG. 2, will be used as an example. However, the description of the natural language representing the combinatorial optimization problem may be a description other than English.

The description of the natural language representing a combinatorial optimization problem includes, for example, a description of a constant, a description of a variable to be optimized, a description of a constraint of the combinatorial optimization problem (hereinafter simply referred to as constraint), and a description of an objective function. In the example shown in FIG. 2, the first sentence is the description of the constant. The second sentence is the description of the variable to be optimized. The third sentence is the description of the constraint. The fourth sentence is the description of the objective function.

In the following explanation, the case in which the description of the natural language representing a combinatorial optimization problem includes the description of a constant, the description of a variable to be optimized, the description of a constraint, and the description of an objective function will be mainly used. However, either the description of the constraint or the description of the objective function may be omitted.

The synonym storage unit 4 is a storage device that stores multiple pairs of synonyms.

When the description of the natural language representing a combinatorial optimization problem is input, the normalization unit 2 refers to the pairs of synonyms stored in the synonym storage unit 4 and unifies the synonyms in the input description into a single word. In addition, the normalization unit 2 removes a line feed character, a comma, and a period from each sentence in the description of the natural language representing the combinatorial optimization problem. However, the normalization unit 2 excludes from deletion a comma in parentheses such as (u, v), for example. The normalization unit 2 also excludes a period for expressing operations (e.g., a period for expressing the inner product operation area [u].dot(area [v])) from deletion.

The unification of synonyms into a single word and the deletion of a line feed character, a comma, and a period from each sentence in the input description are referred to as normalization in the present example embodiment. In the example shown in FIG. 2, synonyms are not included, so the process of unifying synonyms into a single word is not performed.

The conversion unit 3 generates a program for deriving the QUBO matrix, by converting the description after normalization (the description of the natural language representing the combinatorial optimization problem) into the description of a program for deriving the QUBO matrix. In the present example embodiment, the case where the program is a PyQUBO program is exemplified. Therefore, the conversion unit 3 converts the description of the natural language after normalization into the description of the PyQUBO program and generates the PyQUBO program.

The pattern storage unit 5 is a storage device that stores a plurality of pairs of a predetermined pattern of the description of the natural language and a description of a program corresponding to the predetermined pattern (in the present example embodiment a description of a program in PyQUBO). The pattern storage 5 may also store information in which a predetermined pattern of the description of the natural language and an instruction when the predetermined pattern is detected are associated.

The conversion unit 3 detects a predetermined pattern in the description of the natural language representing the combinatorial optimization problem by referring to each pair stored in the pattern storage unit 5, and converts the predetermined pattern into the description of the program corresponding to the predetermined pattern. The conversion unit 3 repeats this process to generate the program for deriving the QUBO matrix.

The following is a specific example of the operation of the conversion unit 3, using the description of the natural language shown in FIG. 2 (the description of the natural language representing the vertex covering problem) as an example.

First, a specific example of conversion of the description of the constant will be explained.

It is assumed that a pair of a pattern “As constant let “(A)” be (B) {and “(C)″ be (D)}” and a description of the program

“(A) = (B)
{(C) = (D)}”

is stored in the pattern storage unit 5. Here, {} means that the description in the parentheses does not have to exist, and that there can be multiple descriptions similar to the description in the parentheses.

The conversion unit 3 detects the first sentence in the normalized description as the pattern corresponding to “As constant let “(A)” be (B) {and “(C)″ be (D)}”. That is, the conversion unit 3 detects “As constant let “edges” be [(0,1), (0,4), (0,5), (1,2), (1,3), (3,4), (4,5)] and “num_vertices” be 6″, and converts this pattern into the description of the program shown below.

edges = [(0,1), (0,4), (0,5), (1,2), (1,3), (3,4), (4,5)]
num_vertices = 6

Next, a specific example of conversion of the description of the variable to be optimized will be explained.

It is assumed that a pair of a pattern “The variable to be optimized is “(A)[(B)]″” and a description of the program “(A) = Array.create(‘(A)’, shape=(B), vartype=’ BINARY’)” is stored in the pattern storage unit 5.

The conversion unit 3 detects the second sentence in the normalized description as the pattern corresponding to “The variable to be optimized is “(A)[(B)]″”. That is, the conversion unit 3 detects “The variable to be optimized is “vertex[num_vertices]″”, and converts this pattern into the description of the program shown below.

vertex = Array.create(‘vertex’, shape=num_vertices, vartype=‘BINARY’)

The above example shows a case in which the conversion unit 3 converts a pattern containing a description of a variable of a one-dimensional array called (A)[(B)] into a description of the program. The conversion unit 3 may convert a pattern that includes a description of a variable of an array of two or more dimensions into a description of the program.

In this case, for example, a pair of a pattern “The variable to be optimized is “(A)[(B)][(C)]″” and a description of the program “(A) = Array.create(‘(A)′, shape=((B),(C)), vartype=‘BINARY’)” may be stored in the pattern storage unit 5. In this case, when the conversion unit 3 detects a part that matches the pattern “The variable to be optimized is “(A)[(B)][(C)]″” including the description of the variable of the two-dimensional array, the conversion unit 3 may convert the part into a description of the program based on the above pair.

For example, the conversion unit 3 may convert a pattern containing a description of multiple variables into a description of the program.

In this case, for example, a pair of a pattern “The variable to be optimized is

“(A)[(B)]” and “(C)[(D)]”“ and a description of the program
“(A) = Array.create(‘(A)’, shape=(B), vartype=‘BINARY’)
(C) = Array.create(‘(C)’, shape=(D), vartype=‘BINARY’)”

may be stored in the pattern storage unit 5. In this case, when the conversion unit 3 detects a part that matches the pattern “The variable to be optimized is “(A)[(B)]” and “(C)[(D)]″”, which contains the description of two variables, the conversion unit 3 may convert the part into a two-line description of the program based on the above pair.

Next, a specific example of conversion of the description of the constraint will be explained.

In this example, it is assumed that information in which a pattern “The constraint is that (A)” and following instructions are associated is stored in the pattern storage unit 5.

The contents of the instructions are as follows.

### Instructions

If the part corresponding to (A) contains a pattern “for all (B) elements (C) (D)”, then “for all (B) elements (C)” is converted into a description of the program “for (C) in (B)”. If the part corresponding to (D) contains a pattern “either (E) or (F) is 1”, then “either (E) or (F) is 1” is converted into a description of the program “(1-(E))*(1-(F))”. Furthermore, the above conversion results are concatenated to generate a description “(1-(E))*(1-(F)) for (C) in (B)”, and based on this description, a description of the program “H_const = Constraint(sum((1-(E))*(1-(F)) for (C) in (B)), ‘const’)″ is generated.

The conversion unit 3 detects the third sentence in the normalized description as the pattern corresponding to “The constraint is that (A)”. That is, the conversion unit 3 detects “The constraint is that for all edges elements (u, v) either vertex[u] or vertex[v] is 1”. In this case, the conversion unit 3 generates a description of the program according to the above instructions.

In this example, the description corresponding to (A) is “for all edges elements (u, v) either vertex[u] or vertex[v] is 1”. This description corresponds to the pattern “for all (B) elements (C) (D)”. That is, “edges” corresponds to (B), “(u, v)” corresponds to (C), and “either vertex[u] or vertex[v] is 1” corresponds to (D). In this case, the conversion unit 3 converts “for all edges elements (u, v)” into a description of the program “for (u, v) in edges”.

In the description “either vertex[u] or vertex[v] is 1”, vertex[u] corresponds to (E) in the above instructions and vertex[v] corresponds to (F) in the above instructions. Therefore, the conversion unit 3 converts the description “either vertex[u] or vertex[v] is 1” into a description of the program “(1- vertex[u])*(1- vertex[v])”.

Then, the conversion unit 3 concatenates “(1- vertex[u])*(1- vertex[v])” and “for (u, v) in edges” to generate the description “(1- vertex[u])*(1- vertex[v]) for (u, v) in edges”, and based on this description, generates a description of the program “H_const = Constraint(sum((1- vertex[u])*(1- vertex[v]) for (u, v) in edges), ‘const’)”.

In other words, the conversion unit 3 converts the normalized description of the natural language “The constraint is that for all edges elements (u, v) either vertex[u] or vertex[v] is 1” into the description of the program “H_const = Constraint(sum((1-vertex[u])*(1- vertex[v]) for (u, v) in edges), ‘const’)”.

When the user creates the description of the constraint in the natural language, the user may incorporate a description of the program into the description. For example, in the example above, the part “either vertex[u] or vertex[v] is 1” in the third sentence may be described as “(1- vertex[u])* (1- vertex[v]) is 0”. In this case, no pattern of the natural language that matches “(1- vertex[u])*(1- vertex[v]) is 0” is stored in the pattern storage unit 5. The conversion unit 3 determines that a description of the natural language that does not match any of the patterns stored in the pattern storage unit 5 is a description of the program, and the description of the program should be the description of the program after conversion. In the case of this example, the description of the program “(1- vertex[u])*(1- vertex[v])”, which excludes “is 0” from “(1-vertex[u])*(1- vertex[v]) is 0”, may be determined as conversion result of “(1-vertex[u])*(1- vertex[v]) is 0”. When incorporating the description of the program into the description of the constraint of the natural language, the user adds a phrase such as “is 0” as described above to make the description read like a description of the natural language. Therefore, when there is a description of the natural language that does not match any of the patterns stored in the pattern storage unit 5, and the description is determined to be a description of the program, the rule that “is 0” in the description is excluded may be established in advance.

For example, the part corresponding to (A) in the pattern “The constraint is that (A)” may be described as “sum((1- vertex[u])*(1- vertex[v]) for (u, v) in edges) is 0”. In this case, the pattern corresponding to this description is not stored in the pattern storage unit 5. Therefore, in this case, the conversion unit 3 determines that “sum((1-vertex[u])*(1- vertex[v]) for (u, v) in edges) is 0” is a description of the program. The conversion unit 3 excludes “is 0” from “sum((1- vertex[u])*(1- vertex[v]) for (u, v) in edges) is 0”, specifies the description “sum((1- vertex[u])*(1- vertex[v]) for (u, v) in edges)”, and determines that “sum((1- vertex[u])*(1- vertex[v]) for (u, v) in edges)” is the result of the conversion of the description corresponding to (A). Then, the conversion unit 3 may generates a description of the program “H_const = Constraint(sum((1- vertex[u])*(1- vertex[v]) for (u, v) in edges), ‘const ’)”, using the description.

In the description of the natural language, multiple constraints may be described in the part corresponding to (A) in the pattern “The constraint is that (A)”. In such a case, the conversion unit 3 may convert each of the multiple constraints into a description of the program. Then, the conversion unit 3 may concatenate the multiple descriptions of the program within the parentheses of the description “H_const = Constraint(, ‘const’)″ using the “+” sign.

Next, a specific example of conversion of the description of the objective function will be explained.

In this example, it is assumed that information in which a pattern “The objective function is to minimize (A)” and following instructions are associated is stored in the pattern storage unit 5.

The contents of the instructions are as follows.

### Instructions

If the part corresponding to (A) contains a pattern “sum of (B)”, “sum of (B)” is converted into a description of the program “sum((B))” and based on this description, a description of the program “H_obj = sum((B))” is generated.

The conversion unit 3 detects the fourth sentence in the normalized description as the pattern corresponding to “The objective function is to minimize (A)”. That is, the conversion unit 3 detects “The objective function is to minimize the sum of vertex”. In this case, the conversion unit 3 generates a description of the program according to the above instructions.

In this example, the description corresponding to (A) is “the sum of vertex”. This description contains the pattern “sum of (B)”. The description “vertex” corresponds to (B). In this case, the conversion unit 3 converts “sum of vertex” into a description of the program “sum(vertex)”, and, based on this description, generates a description of the program “H_obj = sum(vertex)”.

In other words, the conversion unit 3 converts the normalized description of the natural language “The objective function is to minimize the sum of vertex” into the description of the program “H_obj = sum(vertex)”.

When the user creates the description of the objective function in the natural language, the user may incorporate a description of the program into the description. For example, the fourth sentence may be a description “The objective function is to minimize sum(vertex)”. In this case, a pattern of the natural language corresponding to “sum(vertex)” is not stored in the pattern storage unit 5. Therefore, the conversion unit 3 may determine that (A) in the pattern “The objective function is to minimize (A)” is a description of the program, and generate a description of the program “H_obj = sum(vertex)” using “sum(vertex)” as it is.

If the conversion unit 3 has converted the description of the constant, the description of the variable to be optimized, the description of the constraint, and the description of the objective function of the natural language into descriptions of the program, respectively, the conversion unit 3 arranges (lists) the descriptions of the program in that order.

The conversion unit 3 adds a predetermined description of the program to the beginning and the end of the program arranged as above.

The description of the program to be added to the beginning of the program arranged as above is “from pyqubo import Array, Constraint, Placeholder” in the present example embodiment.

The description of the program to be added to the end of the program arranged as above is the following five lines of description in the present example embodiment.

H = H_obj + Placeholder(‘lambda’) * H_const
model = H.compile()
param_lambda = 1.0
feed_dict = {‘lambda’: param_lambda}
qubo, offset = model.to_qubo(feed_dict=feed_dict)

In the above description, “param_lambda = 1.0” represents a value of a variable to balance between the constraint and the objective function. In the above example, this value is set to “1.0”, but the user may specify this value in advance.

As mentioned above, either the description of the constraint or the description of the objective function may be omitted in the input description of the natural language. When the description of the constraint is omitted in the description of the natural language, there is no description of the program related to the constraint. When the description of the objective function is omitted in the description of the natural language, there is no description of the program related to the objective function.

When the description of the objective function is omitted in the description of the natural language and there is no description of the program related to the objective function, the description “H = Placeholder(‘lambda’) * H_const” can be used instead of the above description “H = H_obj + Placeholder(‘lambda’) * H_const”. This specific example is described below.

When the description of the natural language illustrated in FIG. 2 (the description of the natural language representing the vertex covering problem) is input to the program generation device 1, the conversion unit 3 generates the program shown in FIG. 3, by conversion according to the example above. According to the program of PyQUBO shown in FIG. 3, the QUBO matrix can be derived, and by inputting the QUBO matrix to the solver, the solver can solve the vertex covering problem.

The pairs of a predetermined pattern of the description of the natural language and the description of the program corresponding to the predetermined pattern, and the information in which the predetermined pattern of the description of the natural language and an instruction when the predetermined pattern is detected are associated, stored in the pattern storage unit 5, are not limited to the aforementioned examples.

The normalization unit 2 and the conversion unit 3 are realized, for example, by a CPU (Central Processing Unit) of a computer operating according to a program generation program. In this case, the CPU may read the program generation program from a program storage medium such as a program storage device of the computer, and operate as the normalization unit 2 and the conversion unit 3 according to the program generation program.

The synonym storage unit 4 and the pattern storage unit 5 are realized, for example, by a storage device provided by the computer.

Next, the processing flow will be described. FIG. 4 is a flowchart showing an example of a processing flow of the example embodiment of the present invention. Matters that have already been explained will be omitted as appropriate. In the following, the case where the description of the natural language representing a combinatorial optimization problem includes the description of the constant, the description of the variable to be optimized, the description of the constraint, and the description of the objective function is exemplified and explained.

A description of the natural language representing a combinatorial optimization problem is input to the normalization unit 2 via an input device (not shown in FIG. 1). Then, the normalization unit 2 unifies the synonyms in the input description of the natural language into a single word, and removes a line feed character, a comma, and a period for each sentence in the description (step S1). When the input description of the natural language does not contain any synonyms, the process of unifying synonyms into a single word need not be performed.

After step S1, the conversion unit 3 converts the description of the constant of the natural language into a description of the program based on the pair of the pattern “As constant let “(A)” be (B) {and “(C)″ be (D)}” and the description of the program corresponding to the pattern (step S2).

The conversion unit 3 converts the description of the variable to be optimized of the natural language into a description of the program based on the pair of the pattern “The variable to be optimized is “(A)[(B)]″” and the description of the program corresponding to the pattern (step S3).

The conversion unit 3 converts the description of the constraint of the natural language into a description of the program based on the information in which the pattern “The constraint is that (A)” and the instructions corresponding to the pattern are associated (step S4).

A description of the program may be incorporated into the description of the constraint of the natural language. Examples of cases in which a description of the program is incorporated into the description of the constraint of the natural language have already been described, and are omitted here.

The conversion unit 3 converts the description of the objective function of the natural language into a description of the program based on the information in which the pattern “The objective function is to minimize (A)” and the instructions corresponding to the pattern are associated (step S5).

A description of the program may be incorporated into the description of the objective function of the natural language. Examples of cases in which a description of the program is incorporated into the description of the objective functions of the natural language have already been described, and are omitted here.

Next, the conversion unit 3 arranges the description of the program related to the constant, the description of the program related to the variable to be optimized, the description of the program related to the constraint, and the description of the program related to the objective function, and adds the predetermined description of the program at the beginning and at the end (Step S6).

As a result, a program for deriving the QUBO matrix as illustrated in FIG. 3 is generated. As already explained, according to this program, the QUBO matrix can be derived, and by inputting the QUBO matrix to the solver, the solver can solve the combinatorial optimization problem.

As already mentioned, it is relatively easy for users to describe a combinatorial optimization problem in natural language. Then, according to the present example embodiment, the conversion unit 3 generates the program for deriving the QUBO matrix, by converting the description of the natural language representing the combinatorial optimization problem into a description of the program (e.g. a description of PyQUBO program) for deriving the QUBO matrix. Thus, according to the present example embodiment, the program for deriving the QUBO matrix can be generated based on the description of the natural language representing a combinatorial optimization problem.

In the above example embodiment, for example, the program generation device may be configured to additionally store pairs of a predetermined pattern of the description of the natural language and a description of a program corresponding to the predetermined pattern in the pattern storage unit 5. For example, when a new pair (a pair of a predetermined pattern of the description of the natural language and a description of a program corresponding to the predetermined pattern) is input via a keyboard or other input device, additional storage means may additionally store the pair in the pattern storage unit 5. The additional storage means is realized, for example, by the CPU of the computer operating according to the program generation program. Similarly, the program generation device may be configured to additionally store the information in which a predetermined pattern of the description of the natural language and an instruction when the predetermined pattern is detected are associated in the pattern storage unit 5.

For example, in the traveling salesman problem, the sentence “The constraint is that only one of the city’s 0th dimension is one, and only one of the city’s 1st dimension is one.” is often used as the description of the constraint. In this case, a pair of a pattern of the natural language “only one of the city’s 0th dimension is one and only one of the city’s 1st dimension is one” and a description of the program “sum((sum(city[i][j] for j in range(num_cities)) - 1) * (sum(city[i][j] for j in range(num_cities)) - 1) for i in range(num_cities)) + sum((sum(city[i][j] for i in range(num_cities)) - 1) * (sum(city[i][j] for i in range(num_cities)) - 1) for j in range(num_cities))” may be additionally stored in the pattern storage unit 5.

In this case, the conversion unit 3 converts the pattern of the natural language “only one of the city’s 0th dimension is one and only one of the city’s 1st dimension is one”, which corresponds to (A) in the pattern “The constraint is that (A)”, into the description of the program “sum((sum(city[i][j] for j in range(num_cities)) - 1) * (sum(city[i][j] for j in range(num_cities)) - 1) for i in range(num_cities)) + sum((sum(city[i][j] for i in range(num_cities)) - 1) * (sum(city[i][j] for i in range(num_cities)) - 1) for j in range(num_cities))”. Then, based on this description of the program, a description of the program “H_const = Constraint(sum((sum(city[i][j] for j in range(num_cities)) - 1) * (sum(city[i][j] for j in range(num_cities)) - 1) for i in range(num_cities) ) + sum((sum(city[i][j] for i in range(num_cities)) - 1) * (sum(city[i][j] for i in range(num_cities)) - 1) for j in range(num_cities) ), ‘const’) may be generated.

In this example, the pattern of the natural language “only one of the city’s 0th dimension is one and only one of the city’s 1st dimension is one” contains the descriptions of two constraints. In the description of the program, these two constraints are concatenated by the “+” sign within the parentheses of the description “H_const = Constraint(, ‘const’)″. That is, the description of the program corresponding to the first constraint “sum((sum(city[i][j] for j in range(num_cities)) - 1) * (sum(city[i][j] for j in range(num_cities)) - 1) for i in range(num_cities) )” and the description of the program corresponding to the second constraint “sum((sum(city[i][j] for i in range(num_cities)) - 1) * (sum(city[i][j] for i in range(num_cities)) - 1) for j in range(num_cities) )” are concatenated by the “+” sign.

The following is an example of the description of the natural language representing a combinatorial optimization problem, and the program (the program for deriving the QUBO matrix) generated by the program generation device 1 of the present example embodiment based on the description of the natural language. It is assumed that the pattern storage unit 5 stores the pairs of a predetermined pattern of the description of the natural language and a description of the program corresponding to the predetermined pattern, and information in which a predetermined pattern of the description of the natural language and an instruction when the predetermined pattern is detected are associated, which are necessary to generate the programs shown in the examples below.

FIG. 5 is a diagram showing an example of a description of the natural language representing a four color problem. In the example shown in FIG. 5, the first sentence is the description of the constant. The second sentence is the description of the variable to be optimized. The third sentence is the description of the constraints. The description of the constraints include a constraint “only one of the area’s 0th dimension is one” and a constraint “for all graph elements (u, v), area[u].dot(area[v]) is 0” (see FIG. 5). In other words, two constraints are included in the description of the constraints. Note that “.dot″ represents an inner product operation. The example shown in FIG. 5 does not include the description of the objective function.

Based on the description of the natural language representing a four color problem illustrated in FIG. 5, the program shown in FIG. 6 can be obtained by the program generation device 1 of the present example embodiment. FIG. 6 shows a program for deriving the QUBO matrix corresponding to the four color problem shown in FIG. 5. As mentioned above, two constraints are included in the description of the constraints shown in FIG. 5. Thus, in the program shown in FIG. 6, in the description “H_const = Constraint(sum((sum(area[i][j] for j in range(num_colors)) - 1) * (sum(area[i][j] for j in range(num_colors)) - 1) for i in range(num_areas)) + sum(area[u].dot(area[v]) for (u, v) in graph), ‘const’)”, the description of the program corresponding to the first constraint “sum((sum(area[i][j] for j in range(num_colors)) -1) * (sum(area[i][j] for j in range(num_colors)) - 1) for i in range(num_areas))” and the description of the program corresponding to the second constraint “sum(area[u].dot(area[v]) for (u, v) in graph)” are concatenated by the “+” sign.

In addition, the example shown in FIG. 5 does not include the description of the objective function. Therefore, the program shown in FIG. 6 does not include a description of the program related to the objective function. As a result, in the fifth line from the bottom in FIG. 6, instead of the description “H = H_obj + Placeholder(‘lambda’) * H_const”, the description “H = Placeholder(‘lambda’) * H_const” is used.

FIG. 7 is a diagram showing an example of a description of the natural language representing a traveling salesman problem. In the example shown in FIG. 7, the first sentence is the description of the constant. The second sentence is the description of the variable to be optimized. The third sentence is the description of the constraints. The third sentence is the description already illustrated and contains two constraints. The fourth sentence is the description of the objective function.

Based on the description of the natural language representing a traveling salesman problem illustrated in FIG. 7, the program shown in FIG. 8 can be obtained by the program generation device 1 of the present example embodiment. FIG. 8 shows a program for deriving the QUBO matrix corresponding to the traveling salesman problem shown in FIG. 7. Two constraints are included in the description of the constraints shown in FIG. 7. Thus, in the program shown in FIG. 8, in the description “H_const = Constraint(sum((sum(city[i][j] for j in range(num_cities)) - 1) * (sum(city[i][j] for j in range(num_cities)) - 1) for i in range(num_cities)) + sum((sum(city[i][j] for i in range(num_cities)) - 1) * (sum(city[i][j] for i in range(num_cities)) - 1) for j in range(num_cities)), ‘const’)”, the description of the program corresponding to the first constraint and the description of the program corresponding to the second constraint are concatenated by the “+” sign.

The programs illustrated in FIG. 6 and FIG. 8 are PyQUBO programs.

The solver may accept not only the input of the QUBO matrix, but also the input of a constraint of a combinatorial optimization problem. The conversion unit 3 may not only generate the program for deriving the QUBO matrix, as in the above example embodiment, but also convert the description of the natural language related to the constraint into a description of the constraint in a format appropriate for the solver, and output the program and the results of the conversion of the description of constraint. In this case, it will be easier to use the solver where the QUBO matrix and the constraint of a combinatorial optimization problem are input.

FIG. 9 is a schematic block diagram showing an example of computer configuration related to the program generation device 1 of the example embodiment of the present invention. The computer 1000 includes a CPU 1001, a main memory 1002, an auxiliary memory 1003, an interface 1004, and an input device 1005 (e.g., keyboard, etc.).

The program generation device 1 of the example embodiment of the present invention is realized by a computer 1000. The operation of the program generation device 1 is stored in the auxiliary memory 1003 in the form of a program generation program. The CPU 1001 reads the program from the auxiliary memory 1003, expands the program in the main memory 1002, and executes the process described in the above example embodiment according to the program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 may expand the program in the main memory 1002 and execute the process described in the above example embodiment according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

Next, an overview of the present invention is described. FIG. 10 is a block diagram showing an overview of the program generation device of the present invention. The program generation device 1 of the present invention includes conversion means 72.

The conversion means 72 (e.g., the conversion unit 3) generates a program for deriving a QUBO matrix that is a matrix that defines an energy function of QUBO, by converting a description of a natural language representing a combinatorial optimization problem into a description of the program for deriving the QUBO matrix.

According to such a configuration, it is possible to generate a program for deriving a QUBO matrix based on a description of a natural language representing a combinatorial optimization problem.

The conversion means 72 may detect a predetermined pattern in the description of the natural language representing the combinatorial optimization problem, and convert the predetermined pattern into the description of the program corresponding to the predetermined pattern.

The program generation device may comprise pattern storage means (e.g., the pattern storage unit 5) for storing a plurality of pairs of the predetermined pattern of the description of the natural language and the description of the program corresponding to the predetermined pattern.

A pair of the predetermined pattern of the description of the natural language and the description of the program corresponding to the predetermined pattern may be additionally stored in the pattern storage means.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applied to a program generation device that generates a program for deriving a QUBO matrix.

### REFERENCE SIGNS LIST

1 Program generation device
2 Normalization unit
3 Conversion unit
4 Synonym storage unit
5 Pattern storage unit

What is claimed is:

1. A program generation device comprising:
a memory configured to store instructions; and
a processor configured to execute the instructions to:
qenerate a program for deriving a QUBO (Quadratic Unconstrained Binary Optimization) matrix that is a matrix that defines an energy function of QUBO, by converting a description of a natural language representing a combinatorial optimization problem into a description of the program for deriving the QUBO matrix.

2. The program generation device according to claim 1,
wherein the processor
detects a predetermined pattern in the description of the natural language representing the combinatorial optimization problem, and converts the predetermined pattern into the description of the program corresponding to the predetermined pattern.

3. The program generation device according to claim 2, comprising:
a pattern storage for storing a plurality of pairs of the predetermined pattern of the description of the natural language and the description of the program corresponding to the predetermined pattern.

4. The program generation device according to claim 3,
wherein a pair of the predetermined pattern of the description of the natural language and the description of the program corresponding to the predetermined pattern can be additionally stored in the pattern storage.

5. A program generation method, implemented by a computer, comprising:
generating a program for deriving a QUBO (Quadratic Unconstrained Binary Optimization) matrix that is a matrix that defines an energy function of QUBO, by converting a description of a natural language representing a combinatorial optimization problem into a description of the program for deriving the QUBO matrix.

6. The program generation method according to claim 5,
wherein the computer
detects a predetermined pattern in the description of the natural language representing the combinatorial optimization problem, and converts the predetermined pattern into the description of the program corresponding to the predetermined pattern.

7. A non-transitory computer-readable recording medium in which a program generation program is recorded, wherein the program generation program causes a computer to execute:
a conversion process of generating a program for deriving a QUBO (Quadratic Unconstrained Binary Optimization) matrix that is a matrix that defines an energy function of QUBO, by converting a description of a natural language representing a combinatorial optimization problem into a description of the program for deriving the QUBO matrix.

8. The non-transitory computer-readable recording medium in which the program generation program is recorded, according to claim 7,
wherein the program generation program causes a computer to execute, in the conversion process:
detecting a predetermined pattern in the description of the natural language representing the combinatorial optimization problem, and converting the predetermined pattern into the description of the program corresponding to the predetermined pattern.
